(19) United States
(12) Patent Application Publication
(10) Pub. No.: US 2026/0157264 A1
(43) Pub. Date: Jun. 11, 2026

(54) System for Planting Seeds, and Related Row Unit and Methods

(71) Applicant: Precision Planting LLC, Tremont, IL (US)

(72) Inventor: Jeremy J. Hodel, Morton, IL (US)

(21) Appl. No.: 18/706,508

(22) PCT Filed: Nov. 10, 2022
(86) PCT No.: PCT/IB2022/060819

§ 371 Date: May 1, 2024

Related U.S. Application Data
(60) Provisional application No. 63/265,107, filed on Dec. 8, 2021.

(30) Foreign Application Priority Data
Dec. 23, 2021 (GB) 2118881.8

(51) Int. Cl. A01C 7/20; A01C 5/06; A01C 19/02

(52) U.S. Cl. CPC A01C 7/20; A01C 5/064; A01C 5/068; A01C 19/02

(57) ABSTRACT

A system for planting seeds (106) includes a seed meter (128) configured to provide seeds, and a delivery wheel assembly (130) configured to receive the seeds individually from the seed meter and carry the seeds to a seed trench (104). A row unit (100) for planting seeds includes a frame (110) configured to be coupled to a toolbar (112), a seed-trench opening assembly (120) carried by the frame and configured to form a seed trench, a seed meter configured to provide seeds, and a delivery wheel assembly configured to receive the seeds individually from the seed meter and carry the seeds to the seed trench. Related methods are also disclosed.

### CROSS-REFERENCE TO RELATED APPLICATION

This application claims the benefit of the filing date of U.S. Patent Application 63/265,107, “System for Planting Seeds, and Related Row Units and Methods,” filed Dec. 8, 2021, the entire disclosure of which is incorporated herein by reference.

### FIELD

Embodiments of the present disclosure relate generally to row units used on agricultural vehicles for planting an agricultural crop, and more particularly to seed-delivery systems.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Spacing of seeds can affect yield because plants that are too close together compete for nutrients, and plants too far apart leave wasted space between them. Orientation of seeds can affect time to plant emergence, and therefore, uniformity of plant growth. It would be beneficial to have improved methods of controlling the position and orientation of seeds placed in trenches so that seeds emerge and grow more uniformly.

### BRIEF SUMMARY

In some embodiments, a system for planting seeds includes a seed meter configured to provide seeds, and a delivery wheel assembly configured to receive the seeds individually from the seed meter and carry the seeds to a seed trench.

In certain embodiments, the delivery wheel assembly may include a pair of wheels in contact with one another. The pair of wheels may be oriented non-parallel to one another. Each of the pair of wheels may include a resilient material carried by a hub. The resilient material may include rubber or an elastomer. A release wheel may be arranged to intersect a circumference of the wheels.

In other embodiments, the delivery wheel assembly includes a delivery wheel defining a circumferential channel configured to receive the seeds from the seed meter and carry the seeds to the seed trench. The delivery wheel may include a resilient material defining the circumferential channel. The resilient material may include foam, rubber, or an elastomer. A spreader may be configured to open a space in the circumferential channel to receive the seeds, and may also promote release of the seeds within the seed trench.

The delivery wheel assembly may be driven to rotate by contact with the ground, or by a drive mechanism such as a variable-speed motor configured to operate independent of the seed meter.

In one embodiment, a row unit for planting seeds includes a frame configured to be coupled to a toolbar, a seed-trench opening assembly carried by the frame and configured to form a seed trench, a seed meter configured to provide seeds, and a delivery wheel assembly configured to receive the seeds individually from the seed meter and carry the seeds to the seed trench. The row unit also includes a seed-trench closing assembly carried by the frame and configured to close the seed trench over seeds in the seed trench.

A method of planting seeds with a row unit includes forming a seed trench in soil, transferring seeds from a seed meter to a delivery wheel assembly, rotating the delivery wheel assembly to carry the seeds to the seed trench, releasing the seeds from the delivery wheel assembly within the seed trench, and closing the seed trench over the seeds.

In some embodiments, the seeds may be oriented by the seed meter to a preselected orientation.

In some embodiments, the seeds may be released from the delivery wheel assembly with a preselected orientation (which may be the same or different from the orientation provided by the seed meter). The seeds may be pressed between portions of resilient material to carry the seeds, and a space may be opened between the portions of the resilient material to release the seeds.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified side view of a row unit for planting seeds;

FIG. 2A is a simplified side view of a seed meter and delivery wheel assembly that may be used in the row unit of FIG. 1;

FIG. 2B is a simplified top view of the seed meter and delivery wheel assembly shown in FIG. 2A;

FIG. 2C is a simplified cross-sectional view of the seed meter and delivery wheel assembly shown in FIG. 2A;

FIG. 2D is a simplified perspective view of the seed meter and delivery wheel assembly shown in FIG. 2A;

FIG. 3A is a simplified side view of another seed meter and delivery wheel assembly that may be used in the row unit of FIG. 1;

FIG. 3B is a simplified rear view of the seed meter and delivery wheel assembly shown in FIG. 3A; and

FIG. 4 is a simplified flow chart illustrating a method of planting using the row unit of FIG. 1.

### DETAILED DESCRIPTION

The illustrations presented herein are not actual views of any planter row unit or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

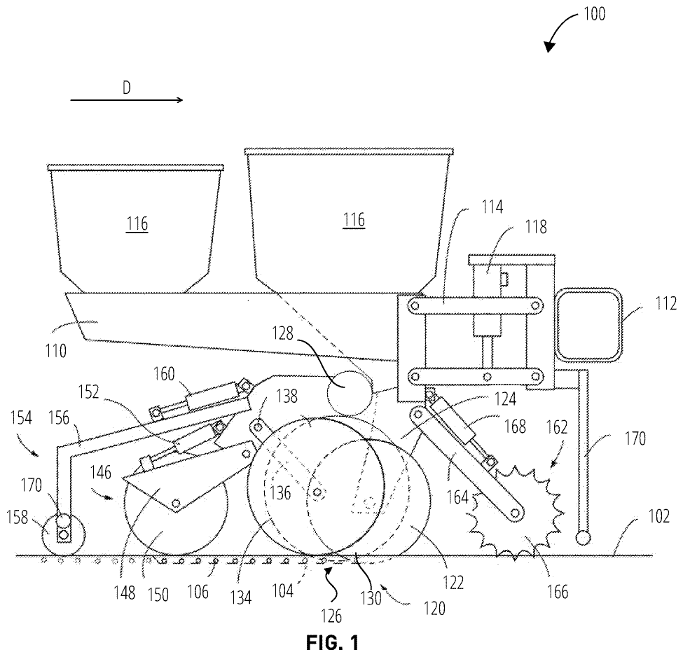

FIG. 1 illustrates an embodiment of an agricultural planter row unit 100. The row unit 100 has a frame 110 pivotally connected to a toolbar 112 by a parallel linkage 114, enabling each row unit 100 to move vertically independently of the toolbar 112 and of other row units 100. The frame 110 operably supports one or more hoppers 108, a downforce control system 118, a seed-trench opening assembly 120, a seed-delivery device 126, a seed-trench closing assembly 146, a packer wheel assembly 154, and a row cleaner assembly 162. The row unit 100 shown in FIG. 1 may be used with a conventional planter or with a central fill planter, in which latter case the hoppers 116 may be replaced with one or more mini-hoppers and the frame 110 modified accordingly as would be recognized by those of skill in the art.

The downforce control system 118 is disposed to apply lift and/or downforce on the row unit 100, such as disclosed in U.S. Pat. No. 9,408,337, “Agricultural Row Unit Apparatus, Systems and Methods,” granted Aug. 9, 2016.

The seed-trench opening assembly 120 includes a pair of opening discs 122 rotatably supported by a downwardly extending shank 124 of the frame 110. The opening discs 122 are arranged to diverge outwardly and rearwardly to open a V-shaped seed trench 104 in the soil 102 as the planter traverses the field in a forward direction D.

The seed-delivery device 126 includes a seed meter 128 that may deliver seeds to a delivery wheel assembly 130. Typically, the seeds provided to the delivery wheel assembly 130 by the seed meter 128 have the same selected orientation. The delivery wheel assembly 130 is configured to receive the seeds from the seed meter 128, and carry the seeds to the seed trench 104. Typically, each seed received from the seed meter 128 is transferred to the seed trench 104 in the same orientation by the delivery wheel assembly 130 (which orientation may be the same or different from the orientation provided by the seed meter 128).

The seed meter 128 may be any commercially available seed meter, such as the fingertype meter or vacuum seed meter, such as the VSet® meter, available from Precision Planting LLC, 23333 Townline Rd, Tremont, Ill. 61568. The seed meter 128 may be configured to orient seeds by any selected method, such as that shown and described in U.S. Patent Application Publication 2019/0230846, “Systems, Implements, and Methods for Seed Orientation with Adjustable Singulators During Planting,” published Aug. 1, 2019.

The depth of the seed trench 104 is controlled by a pair of gauge wheels 134 positioned adjacent to the opening discs 122. The gauge wheels 134 are rotatably supported by gauge wheel arms 136, which are pivotally secured at one end to the frame 110 about pivot pin 138. Rotation of the gauge wheel arm 136 about the pivot pin 142 sets the depth of the seed trench 104 by controlling the position of the gauge wheels 134 relative to the opening discs 122. The gauge wheel arm 136 may be controlled, for example, by a rocker arm and linear actuator mounted to the row unit frame 110. Such a linear actuator may be controlled remotely or automatically actuated as disclosed, for example, in U.S. Pat. No. 9,864,094, “System for Soil Moisture Monitoring,” granted Jan. 9, 2018.

A downforce sensor may be configured to generate a signal related to the amount of force imposed by the gauge wheels 134 on the soil 102. In some embodiments, a pivot pin may comprise the downforce sensor, such as the instrumented pins disclosed in U.S. Pat. No. 8,561,472, “Load Sensing Pin,” granted Oct. 22, 2013.

The seed-trench closing assembly 146 includes a closing wheel arm 148 that pivotally attaches to the row unit frame 110. A pair of offset closing wheels 150 are rotatably attached to the closing wheel arm 148 and are angularly disposed to “close” the seed trench 104 by pushing the walls of the open seed trench back together over the deposited seed 106. An actuator 152 may be pivotally attached at one end to the closing wheel arm 148 and at its other end to the row unit frame 110 to vary the down pressure exerted by the closing wheels 150 depending on soil conditions. The seed-trench closing assembly 146 may be of the type disclosed in U.S. Pat. No. 9,848,524, “Agricultural Seed Trench Closing Systems, Methods, and Apparatus,” granted Dec. 26, 2017.

The packer wheel assembly 154 includes an arm 156 pivotally attached to the row unit frame 110 and extending rearward of the seed-trench closing assembly 146 and in alignment therewith. The arm 156 rotatably supports a packer wheel 158. An actuator 160 is pivotally attached at one end to the arm 156 and at its other end to the row unit frame 110 to vary the amount of downforce exerted by the packer wheel 158 to pack the soil over the seed trench 104.

The row cleaner assembly 162 may be the CleanSweep® system available from Precision Planting LLC, 23333 Townline Rd, Tremont, Ill. 61568. The row cleaner assembly 162 includes an arm 164 pivotally attached to the forward end of the row unit frame 110 and aligned with the seed-trench opening assembly 120. A pair of row cleaner wheels 166 are rotatably attached to the forward end of the arm 164. An actuator 168 is pivotally attached at one end to the arm 164 and at its other end to the row unit frame 110 to adjust the downforce on the arm to vary the aggressiveness of the action of the row cleaner wheels 166 depending on the amount of crop residue and soil conditions.

The row unit 100 may optionally carry other sensors 170 to detect soil conditions before and/or after planting.

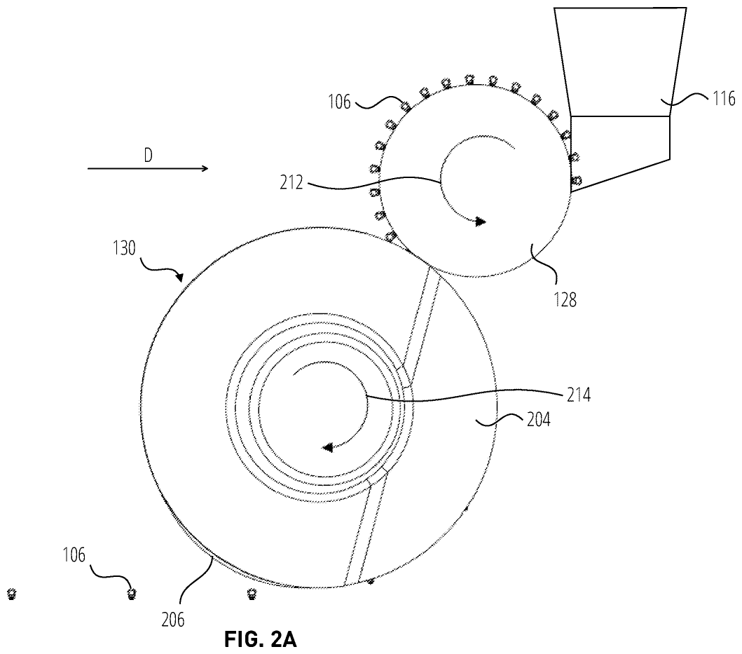

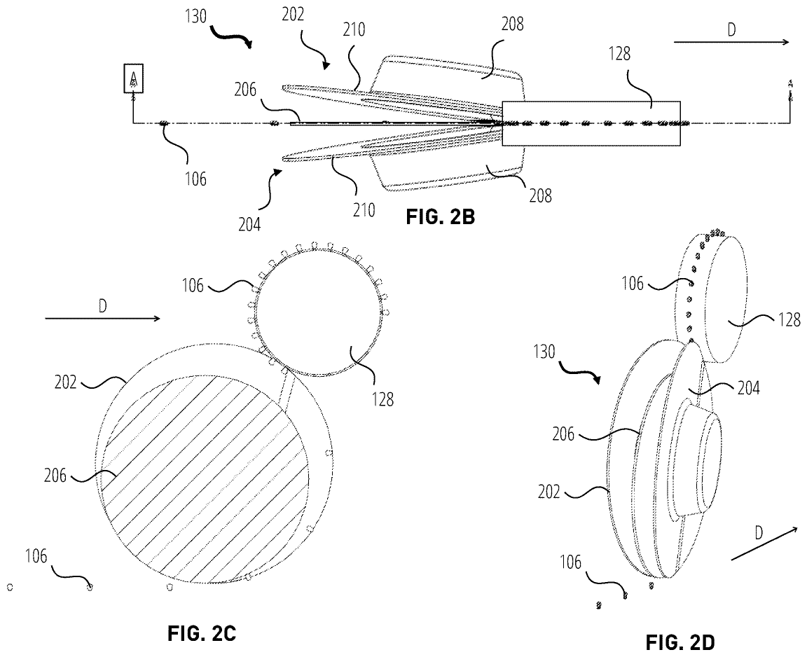

FIG. 2A is a simplified side view of the seed meter 128 and the delivery wheel assembly 130. The seed meter 128 receives seeds 106 from the hopper 116. The seed meter 128 may orient the seeds 106 in a selected manner. For example, and as depicted in FIG. 2A, the seed meter 128 may orient seeds 106 having seed tips with the tips inward toward the center of the seed meter 128. The seed meter 128 may rotate the seeds 106 in a direction 212 about the center of the seed meter 128 and transfer the seeds 106 to the delivery wheel assembly 130. In some embodiments, and as depicted in FIG. 2A, the delivery wheel assembly 130 may receive the seeds 106 individually from the seed meter 128 with seed tips oriented outward from the center of the delivery wheel assembly 130. The delivery wheel assembly 130 rotates in a direction 214 and carries the seeds 106 to the seed trench 104, with the seed tips now oriented downward. Though illustrated with the seed tips oriented downward in the soil, other orientations may be selected, and other types of seeds may be oriented in any appropriate manner. The direction 214 may typically be opposite the direction 212, but the rotational speeds of the seed meter 128 and the delivery wheel assembly 130 need not be the same. In the embodiment pictured, the delivery wheel assembly 130 rotates faster than the seed meter 128 (as indicated by the relative spacing between the seeds 106 on the seed meter 128 and the seeds 106 on the delivery wheel assembly 130). The delivery wheel assembly 130 may be driven to rotate by contact with the ground, and/or by an independent drive mechanism (e.g., a variable-speed motor).

FIG. 2B is a simplified top view of the seed meter 128 and the delivery wheel assembly 130. The delivery wheel assembly 130 may include a left wheel 202 and a right wheel 204 angled relative to one another (i.e., the left wheel 202 and right wheel 204 are oriented non-parallel to one another). The left wheel 202 and right wheel 204 may each be formed at least partially of a resilient material. For example, a hub 208 may be formed of a rigid material (e.g., steel, aluminum, HDPE, etc.), and a rotor 210 may be formed of the resilient material (e.g., rubber, an elastomer, etc.). The left wheel 202 and right wheel 204 may be positioned such that portions of each flex relative to one another. For example, the left wheel 202 and right wheel 204 may flex toward the front, where the left wheel 202 would otherwise interfere with the right wheel 204.

FIG. 2C is a simplified cross section taken along the section A-A in FIG. 2B. FIG. 2D is a simplified perspective view of the seed meter 128 and delivery wheel assembly 130. As shown in FIG. 2C and FIG. 2D, the seeds 106 delivered by the seed meter 128 are held in place between the left wheel 202 and the right wheel 204. The resiliency of the rotors 210 provides a force to maintain the position and orientation (subject to rotation of the left wheel 202 and right wheel 204) of the seeds 106. The release wheel 206 separates the left wheel 202 from the right wheel 204 at a point within the seed trench 104 (FIG. 1). The release wheel 206 may be driven to rotate by the left wheel 202, the right wheel 204, by contact with the ground, and/or by an independent drive mechanism. The circumference of the release wheel 206 may intersect the circumference of the left wheel 202 and the right wheel 204 when viewed from the side (FIG. 2A) or in cross-section (FIG. 2C).

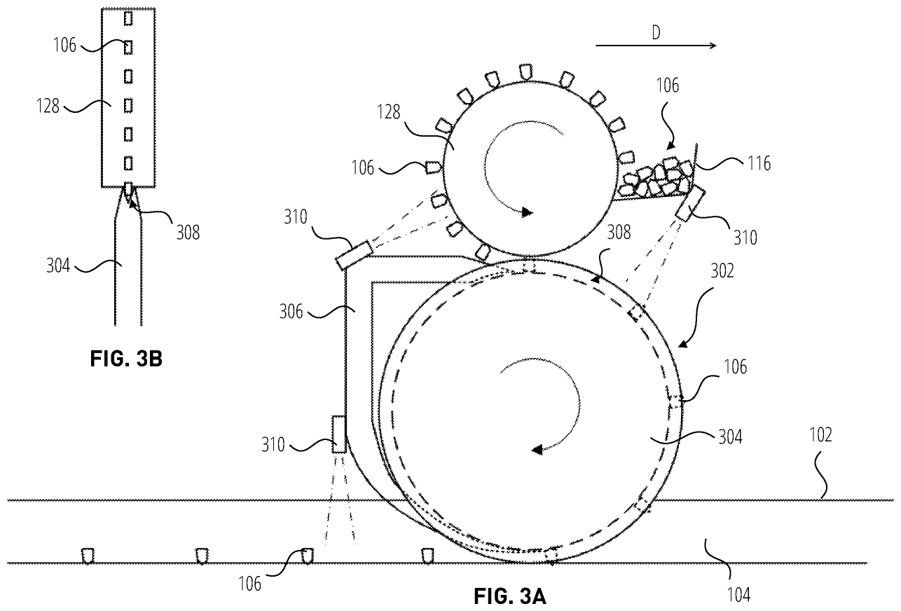

FIG. 3A is a simplified side view of another embodiment of a delivery wheel assembly 302 that can receive seeds from a seed meter 128. As discussed above with respect to FIG. 2A through FIG. 2D, the seed meter 128 receives seeds 106 from a hopper 116 or other seed pool. The seed meter 128 may orient the seeds 106 in a selected way such that each seed 106 reaches the delivery wheel assembly 302 with the same orientation.

The delivery wheel assembly 302 includes a delivery wheel 304 and a spreader 306. The delivery wheel 304 has a circumferential channel 308 in which the seeds 106 can be held. The delivery wheel 304 may include a resilient material (e.g., foam, rubber, an elastomer, etc.) at its outer extent, and the resilient material may define the channel 308.

The spreader 306 may be configured to open the channel 308 to facilitate entry of the seeds 106 into the channel 308 and removal of seeds 106 from the channel 308 at appropriate points. In the view shown in FIG. 3A, the spreader 306 opens (e.g., widens) the channel 308 near the top of the delivery wheel 304, just before a point at which the seed meter 128 provides the seeds 106. After the seeds 106 are within the channel 308, and as the delivery wheel 304 rotates, the portion of the channel 308 on the right side (in the view of FIG. 3A, which is the front of the delivery wheel 304 in the direction D of travel), returns toward its natural state, which may be small enough or tight enough to hold the seeds 106 in place.

As the delivery wheel 304 rotates the seeds 106 downward into the seed trench 104, the spreader 306 again opens (e.g., widens) the channel 308 near the bottom to release the seeds 106 in place within the seed trench 104. This action may limit the amount of bounce the seeds 106 experience, and may therefore improve the consistency of spacing and/or orientation of seeds 106 within the seed trench 104 as compared to conventional seed delivery methods.

In some embodiments, one or more sensors 310 may be configured to detect seeds 106 carried by the seed meter 128 or the delivery wheel assembly 302, or within the seed trench 104. The sensors 310 may include an optical or electromagnetic sensor, for example as described in U.S. Patent Application Publication 2019/0223372 A1, “Systems, Implements, and Methods for Seed Orientation within Agricultural Fields,” published Jul. 25, 2019; and U.S. Patent Application Publication 2019/0230846 A1, “Systems, Implements, and Methods for Seed Orientation with Adjustable Singulators During Planting,” published Aug. 1, 2019.

FIG. 3B is a simplified rear view of the seed meter 128 and a portion of the delivery wheel 304 shown in FIG. 3A, without the spreader 306. As shown, the channel 308 may have an angled profile to retain the seeds 106. Other shapes of the channel 308 may be selected, and different shapes or sizes may be selected for different types of seeds.

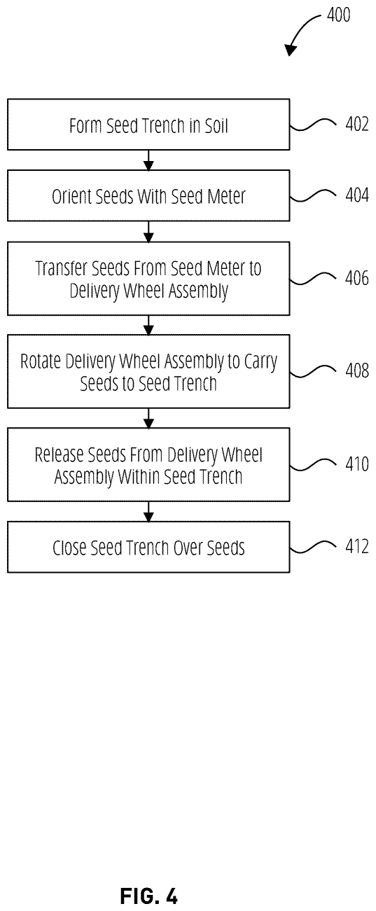

FIG. 4 is a simplified flow chart illustrating a method 400 of planting using a row unit as described above. Block 402 represents forming a seed trench in soil with the row unit. The seed trench may be formed with one or more opening discs carried by the row unit.

In block 404, seeds are optionally oriented by a seed meter carried by the row unit. In block 406, the seeds are transferred from the seed meter to a delivery wheel assembly.

In block 408, the delivery wheel assembly rotates to carry the seeds to the seed trench. In some embodiments, the delivery wheel assembly may press the seeds between portions of resilient material.

In block 410, the seeds are released from the delivery wheel assembly within the seed trench. The seeds may be released with a preselected orientation, such that each of the seeds is oriented in approximately the same way in the ground. If the delivery wheel assembly includes resilient material, opening a space between portions of the resilient material may facilitate release of the seeds in the seed trench. Block 412 represents closing the seed trench over the seeds.

Though depicted as a flow chart, the actions in FIG. 4 are typically performed concurrently by different parts of the row unit. That is, the portion of the row unit that forms the seed trench leads the delivery wheel assembly, which leads the seed-trench closing assembly as the row unit operates to plant seeds. In some embodiments, some actions may be omitted, or may be performed by another device.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

All references cited herein are incorporated herein in their entireties. If there is a conflict between definitions herein and in an incorporated reference, the definition herein shall control.

1. A system for planting seeds, the system comprising:
a seed meter configured to provide seeds; and
a delivery wheel assembly configured to receive the seeds individually from the seed meter and carry the seeds to a seed trench.

2. The system of claim 1, wherein the delivery wheel assembly comprises a pair of wheels in contact with one another.

3. The system of claim 2, wherein the pair of wheels are oriented non-parallel to one another.

4. The system of claim 2, further comprising a release wheel arranged to intersect a circumference of the wheels.

5. The system of claim 2, wherein each of the pair of wheels comprises a resilient material carried by a hub.

6. The system of claim 5, wherein the resilient material comprises a material selected from the group consisting of rubber and elastomers.

7. The system of claim 1, wherein the delivery wheel assembly comprises a delivery wheel defining a circumferential channel configured to receive the seeds from the seed meter and carry the seeds to the seed trench.

8. The system of claim 7, wherein the delivery wheel comprises a resilient material defining the circumferential channel.

9. The system of claim 8, wherein the resilient material comprises a material selected from the group consisting of foam, rubber, and elastomers.

10. The system of claim 7, further comprising a spreader configured to open a space in the circumferential channel to receive the seeds.

11. The system of claim 10, wherein the spreader is further configured to promote release of the seeds within the seed trench.

12. The system of claim 1, further comprising a drive mechanism configured to rotate the delivery wheel assembly.

13. The system of claim 12, wherein the drive mechanism comprises a variable-speed motor.

14. The system of claim 12, wherein the drive mechanism is configured to operate independent of the seed meter.

15. A row unit for planting seeds, comprising:
a frame configured to be coupled to a toolbar;
a seed-trench opening assembly carried by the frame and configured to form a seed trench;
a seed meter configured to provide seeds having a selected orientation;
a delivery wheel assembly configured to receive the seeds individually from the seed meter and carry the seeds to the seed trench; and
a seed-trench closing assembly carried by the frame and configured to close the seed trench over seeds in the seed trench.

16. A method of planting seeds with a row unit, the method comprising:
forming a seed trench in soil;
transferring seeds from a seed meter to a delivery wheel assembly;
rotating the delivery wheel assembly to carry the seeds to the seed trench;
releasing the seeds from the delivery wheel assembly within the seed trench; and
closing the seed trench over the seeds.

17. The method of claim 16, further comprising orienting seeds with the seed meter to a preselected seed orientation.

18. The method of claim 16, wherein releasing the seeds from the delivery wheel assembly comprises releasing the seeds with a preselected orientation.

19. The method of claim 16, wherein rotating the delivery wheel assembly to carry the seeds to the seed trench comprises pressing the seeds between portions of resilient material.

20. The method of claim 19, wherein releasing the seeds from the delivery wheel assembly within the seed trench comprises opening a space between the portions of the resilient material.
